(19) United States
(12) Patent Application Publication
(10) Pub. No.: US 2026/0088917 A1
(43) Pub. Date: Mar. 26, 2026

(54) MEASUREMENT DEVICE AND METHOD FOR DISPLAYING SETTING SCREEN THEREOF

(71) Applicant: ANRITSU CORPORATION, Kanagawa (JP)

(72) Inventor: Yasuko UDA, Kanagawa (JP)

(21) Appl. No.: 19/325,670

(22) Filed: Sep. 11, 2025

(30) Foreign Application Priority Data
Sep. 25, 2024 (JP) 2024-166310

(51) Int. Cl. H04B 17/23; G06F 3/0482; H04B 17/15; H04W 24/08; H04W 84/12

(52) U.S. Cl. CPC H04B 17/23; H04B 17/191; H04W 24/08; G06F 3/0482; H04W 84/12

(57) ABSTRACT

Provided is a measurement device that makes a screen for setting parameters easy to see, makes it possible to easily find a parameter desired to be set, and can suppress parameter setting errors. A measurement device includes a display unit 15 that displays an image and a control unit 16 that switches a setting screen for a Capability Element parameter between a setting screen for SISO communication and a setting screen for MIMO communication and displays the setting screen on the display unit 15 when communication conforming to an IEEE 802.11be standard is measured.

### TECHNICAL FIELD

The present invention relates to a measurement device, and more particularly, to a measurement device that measures a wireless signal transmitted and received by a communication device operating according to a wireless local area network (LAN) communication standard.

### BACKGROUND ART

Various wireless communication technologies have been developed with the advancement of information and communication technologies. For example, Institute of Electrical and Electronics Engineers (IEEE) 802.11ac (Very High Throughput (VHT)) and IEEE 802.11ax (High Efficiency (HE)) are known as communication standards related to the wireless LAN technology among the wireless communication technologies.

In wireless LAN communication, a single-input single-output (SISO) method in which both a transmission side and a reception side perform communication with one antenna, a multiple-input multiple-output (MIMO) method in which both the transmission side and the reception side perform communication with a plurality of antennas, and the like are used.

Patent Document 1 discloses a technique that measures a device under test which performs MIMO communication, using a plurality of SISO-type measurement devices.

### RELATED ART DOCUMENT

### Patent Document

[Patent Document 1] Japanese Patent No. 6672554

### DISCLOSURE OF THE INVENTION

### Problem That the Invention is to Solve

In recent years, IEEE 802.11be, which is an Extremely High Throughput (EHT) wireless LAN standard, has been proposed as the next version of IEEE 802.11ax.

In the IEEE 802.11be standard, a Capability Element parameter makes it possible to set Capability for each Modulation and Coding Scheme (MCS). Therefore, when a measurement device is in an access point (AP) mode, there are nine setting items for the Capability Element parameter. When the measurement device is in a station (STA) mode, there are 13 setting items for the Capability Element parameter.

In the measurement device, in the setting of the items, when setting items for the parameters for MIMO communication are displayed below setting items for the parameters for SISO communication as in the related art, 18 setting items for the parameters are displayed in the AP mode, and 26 setting items for the parameters are displayed in the STA mode. Therefore, it takes a long time for the user to find the parameters desired to be set, or unintended parameters are set, which results in reduced usability.

Therefore, an object of the present invention is to provide a measurement device that makes a screen for setting parameters easy to see, makes it possible to easily find a parameter desired to be set, and can suppress parameter setting errors.

### Means for Solving the Problem

According to an aspect of the present invention, there is provided a measurement device (1) that measures a wireless signal transmitted and received by a communication device (100) to measure transmission and reception characteristics of the communication device. The measurement device includes a display unit (15) that displays an image and a control unit (16) that displays the image on the display unit. When communication conforming to an Institute of Electrical and Electronics Engineers (IEEE) 802.11be standard is measured, the control unit switches a setting screen for a Capability Element parameter between a setting screen for single-input single-output (SISO) communication and a setting screen for multiple-input multiple-output (MIMO) communication and displays the setting screen on the display unit.

According to this configuration, the setting screen for the Capability Element parameter is switched between the setting screen for SISO communication and the setting screen for MIMO communication and is displayed. Therefore, the screen for setting the parameters is easy to see, it is possible to easily find the parameter desired to be set, and it is possible to suppress parameter setting errors.

In addition, in the measurement device according to the aspect of the present invention, the control unit may set initial values of setting values displayed on the setting screen for SISO communication and initial values of setting values displayed on the setting screen for MIMO communication to different values.

According to this configuration, different initial values are displayed on the setting screen for SISO communication and the setting screen for MIMO communication. Therefore, the initial values enable the user to determine whether the setting screen is the setting screen for SISO communication or the setting screen for MIMO communication.

Further, in the measurement device according to the aspect of the present invention, the control unit may set selectable values of setting values displayed on the setting screen for SISO communication and selectable values of setting values displayed on the setting screen for MIMO communication to different values.

Furthermore, according to another aspect of the present invention, there is provided a method for displaying a setting screen of a measurement device (1) that includes a display unit (15) displaying an image and measures a wireless signal transmitted and received by a communication device (100) to measure transmission and reception characteristics of the communication device. The method includes: a step of displaying a setting screen for SISO communication on the display unit when a Capability Element parameter for SISO communication is set in measurement of communication conforming to an IEEE 802.11be standard; and a step of displaying a setting screen for MIMO communication on the display unit when a Capability Element parameter for MIMO communication is set.

According to this configuration, the setting screen for the Capability Element parameter is switched between the setting screen for SISO communication and the setting screen for MIMO communication and is displayed. Therefore, the screen for setting the parameters is easy to see, it is possible to easily find the parameter desired to be set, and it is possible to suppress parameter setting errors.

In addition, in the method for displaying a setting screen according to the present invention, initial values of setting values displayed on the setting screen for SISO communication and initial values of setting values displayed on the setting screen for MIMO communication may be set to different values.

Further, in the method for displaying a setting screen according to the aspect of the present invention, selectable values of setting values displayed on the setting screen for SISO communication and selectable values of setting values displayed on the setting screen for MIMO communication may be set to different values.

### Advantage of the Invention

The present invention can provide a measurement device that makes a screen for setting parameters easy to see, makes it possible to easily find a parameter desired to be set, and can suppress parameter setting errors.

### BRIEF DESCRIPTION OF THE DRAWINGS

FIG. 1 is a block diagram showing a measurement device according to an embodiment of the present invention.

FIG. 2 is a diagram showing an example of a screen for setting SISO communication in the measurement device according to the embodiment of the present invention.

FIG. 3 is a diagram showing an example of a screen for setting MIMO communication in the measurement device according to the embodiment of the present invention.

### BEST MODE FOR CARRYING OUT THE INVENTION

Hereinafter, a measurement device according to an embodiment of the present invention will be described in detail with reference to the drawings.

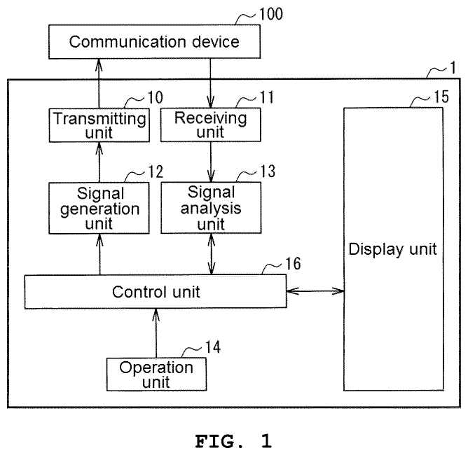

In FIG. 1, a measurement device 1 according to the embodiment of the present invention performs wireless communication with a communication device 100 and performs various types of measurement on a wireless signal transmitted and received by the communication device 100. In the present embodiment, the measurement device 1 operates as a wireless LAN access point (AP), and the communication device 100 operates as a wireless LAN station (STA). However, the present invention is not limited thereto. The measurement device 1 may operate as the STA, and the communication device 100 may operate as the AP. In addition, the measurement device 1 communicates with the communication device 100 according to a communication standard conforming to IEEE 802.11.

The measurement device 1 can perform measurement in both SISO communication and MIMO communication.

The measurement device 1 is configured to include a transmitting unit 10, a receiving unit 11, a signal generation unit 12, a signal analysis unit 13, an operation unit 14, a display unit 15, and a control unit 16.

The transmitting unit 10 performs amplification or frequency conversion on a signal generated by the signal generation unit 12 and transmits the signal to the communication device 100.

The receiving unit 11 performs amplification or frequency conversion on a wireless signal received from the communication device 100 and outputs the wireless signal to the signal analysis unit 13.

The signal generation unit 12 generates a signal including a control packet or a data packet for communicating with the communication device 100 and transmits the signal to the communication device 100 via the transmitting unit 10.

The signal analysis unit 13 analyzes the wireless signal received from the communication device 100 via the receiving unit 11 and performs a process of measuring transmission and reception characteristics of the communication device 100. The transmission and reception characteristics include a packet error rate, an error vector magnitude (EVM), transmission power, and the like.

The operation unit 14 is configured as an input device, such as a keyboard, a mouse, or a touch panel, and outputs information and the like input by an operation to the control unit 16.

The display unit 15 is configured as an image display device, such as a liquid crystal display, and displays an image for inputting information required for measurement, an image indicating measurement results, and the like.

The control unit 16 is configured by a computer unit including a central processing unit (CPU), a random access memory (RAM), a read only memory (ROM), a hard disk device, and an input/output port (which are not shown).

The ROM and the hard disk device of this computer unit store a program for causing the computer unit to function as the control unit 16 together with various control constants, various maps, and the like. That is, the CPU executes the program stored in the ROM and the hard disk device such that the computer unit functions as the control unit 16. In addition, the hard disk device may be, for example, a compact flash (CF) card using a flash memory.

The signal generation unit 12, the signal analysis unit 13, the operation unit 14, and the display unit 15 are connected to the input/output port of the control unit 16 such that the control unit 16 and each unit can transmit and receive signals.

The measurement device 1 according to the present embodiment can measure communication according to the IEEE 802.11be standard. In IEEE 802.11be, 20 MHz, 40 MHz, 80 MHz, 160 MHz, 320 MHz, and the like can be selected as a frequency bandwidth of a channel with a predetermined frequency bandwidth used for communication.

In IEEE 802.11be, a capability element parameter can set capability for each modulation and coding scheme (MCS). Therefore, when the measurement device 1 is in an AP mode, there are nine setting items for a Capability parameter. When the measurement device 1 is in an STA mode, there are 13 setting items for the Capability parameter.

In the measurement device 1, in the setting of these items, when the setting items for MIMO parameters are displayed below the setting items for SISO parameters as in the related art, an area for setting 18 items is displayed in the AP mode, and an area for setting 26 items for parameters is displayed in the STA mode.

Therefore, the measurement device 1 according to the present embodiment switches the setting screen for the Capability Element parameter between a setting screen for SISO communication and a setting screen for MIMO communication and displays the switched setting screen.

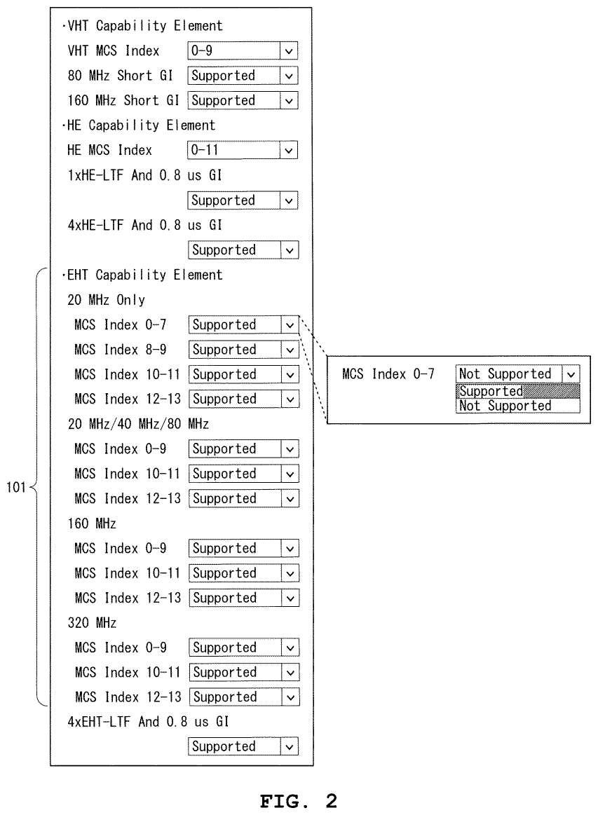

The control unit 16 displays, for example, an image shown in FIG. 2 as the setting screen for the Capability Element parameter when measurement is performed in the SISO communication on the display unit 15 such that the Capability Element parameter is set.

In FIG. 2, an EHT setting portion 101 is an item for setting each MCS of the Capability Element parameter which has been added in IEEE 802.11be.

In the EHT setting portion 101, when the frequency bandwidth of the channel is 20 MHz, the classification of the MCS can be set to “MCS Index 0-7”, “MCS Index 8-9”, “MCS Index 10-11”, and “MCS Index 12-13”. When the frequency bandwidth of the channel is other than 20 MHz, the classification of the MCS can be set to “MCS Index 0-9”, “MCS Index 10-11”, and “MCS Index 12-13”.

In the EHT setting portion 101, as shown in an enlarged view on the right side of FIG. 2, either “Supported” or “Not Supported” can be selected for each item. In addition, the initial value of each item is “Supported”.

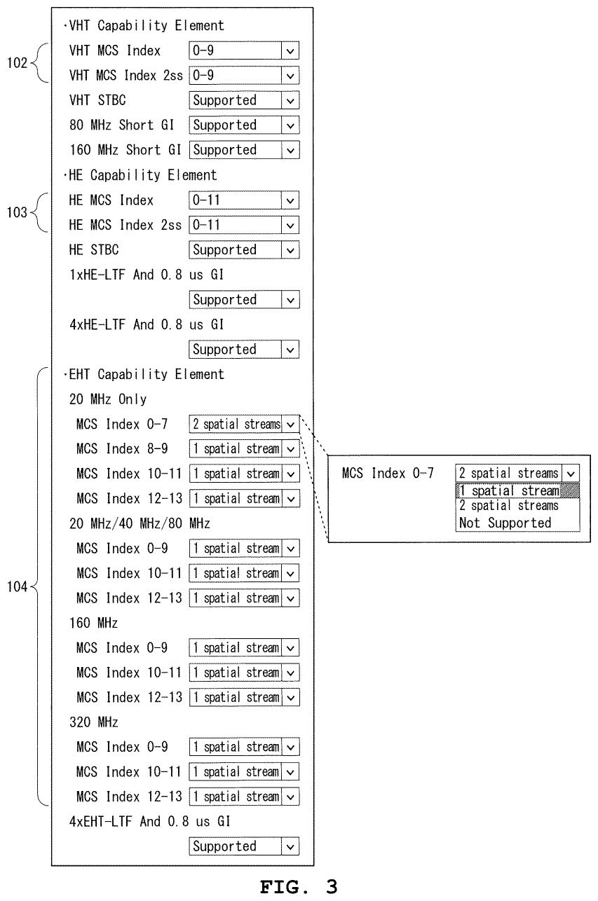

The control unit 16 displays, for example, an image shown in FIG. 3 as the setting screen for the Capability Element parameter when measurement is performed in the MIMO communication on the display unit 15 such that the Capability Element parameter is set.

In FIG. 3, a VHT setting portion 102 is an item for setting the MCS of the Capability Element parameter in IEEE 802.11ac. In the VHT setting portion 102, “VHT MCS Index 2ss” is a setting item for the MIMO communication.

An HE setting portion 103 is an item for setting the MCS of the Capability Element parameter in IEEE 802.11ax. In the HE setting portion 103, “HE MCS Index 2ss” is a setting item for the MIMO communication.

As described above, in IEEE 802.11ac or IEEE 802.11ax, even when the setting items for MIMO communication are displayed below the setting items for SISO communication, the appearance remains largely unchanged, and the operability remains unchanged as well.

In IEEE 802.11be, when a setting portion for MIMO communication that has the same amount of information as the EHT setting portion 101 is displayed below the EHT setting portion 101 for SISO communication in FIG. 2, the number of items increases, resulting in reduced visibility and degraded operability.

Therefore, in the present embodiment, as shown in FIG. 3, only the EHT setting portion 104 for MIMO communication is displayed. In addition, in the SISO communication, the setting values for the MIMO communication are not used. In the MIMO communication, the setting values for the SISO communication are not used. Therefore, there is no need for setting.

In the EHT setting portion 104, as in the EHT setting portion 101 shown in FIG. 2, when the frequency bandwidth of the channel is 20 MHz, the classification of the MCS can be set to “MCS Index 0-7”, “MCS Index 8-9”, “MCS Index 10-11”, and “MCS Index 12-13”. When the frequency bandwidth of the channel is other than 20 MHz, the classification of the MCS can be set to “MCS Index 0-9”, “MCS Index 10-11”, and “MCS Index 12-13”.

In the EHT setting portion 104, as shown in an enlarged view on the right side of FIG. 3, any one of “1 spatial stream”, “2 spatial streams”, and “Not Supported” can be selected for each item. In addition, the initial value of each item is “1 spatial stream”.

As described above, in the above-described embodiment, when communication conforming to the IEEE 802.11be standard is measured, the control unit 16 switches the setting screen for the Capability Element parameter between the setting screen for SISO communication and the setting screen for MIMO communication and displays the switched setting screen on the display unit 15.

Therefore, the setting screen for the Capability Element parameter is switched between the setting screen for SISO communication and the setting screen for MIMO communication and is displayed. Therefore, the screen for setting the parameters is easy to see, it is possible to easily find the parameter desired to be set, and it is possible to suppress parameter setting errors.

In addition, the control unit 16 sets the initial values of the setting values displayed on the setting screen for SISO communication and the setting screen for MIMO communication to different values.

Therefore, different initial values are displayed on the setting screen for SISO communication and the setting screen for MIMO communication. As a result, the initial values enable the user to determine whether the setting screen is the setting screen for SISO communication or the setting screen for MIMO communication.

The embodiment of the present invention has been disclosed, but it is clear that modifications can be made by those skilled in the art without departing from the scope of the present invention. All such modifications and equivalents are intended to be included in the following claims.

### DESCRIPTION OF REFERENCE NUMERALS AND SIGNS

1 Measurement Device
15 Display Unit
16 Control Unit
100 Communication Device

What is claimed is:

1. A measurement device that measures a wireless signal transmitted and received by a communication device to measure transmission and reception characteristics of the communication device, the measurement device comprising:
a display unit that displays an image; and
a control unit that displays the image on the display unit,
wherein, when communication conforming to an Institute of Electrical and Electronics Engineers (IEEE) 802.11be standard is measured, the control unit switches a setting screen for a Capability Element parameter between a setting screen for single-input single-output (SISO) communication and a setting screen for multiple-input multiple-output (MIMO) communication and displays the setting screen on the display unit.

2. The measurement device according to claim 1,
wherein the control unit sets initial values of setting values displayed on the setting screen for SISO communication and initial values of setting values displayed on the setting screen for MIMO communication to different values.

3. The measurement device according to claim 1,
wherein the control unit sets selectable values of setting values displayed on the setting screen for SISO communication and selectable values of setting values displayed on the setting screen for MIMO communication to different values.

4. A method for displaying a setting screen of a measurement device that includes a display unit displaying an image and measures a wireless signal transmitted and received by a communication device to measure transmission and reception characteristics of the communication device, the method comprising:
a step of displaying a setting screen for SISO communication on the display unit when a Capability Element parameter for SISO communication is set in measurement of communication conforming to an IEEE 802.11be standard; and
a step of displaying a setting screen for MIMO communication on the display unit when a Capability Element parameter for MIMO communication is set.

5. The method for displaying a setting screen according to claim 4,
wherein initial values of setting values displayed on the setting screen for SISO communication and initial values of setting values displayed on the setting screen for MIMO communication are set to different values.

6. The method for displaying a setting screen according to claim 4,
wherein selectable values of setting values displayed on the setting screen for SISO communication and selectable values of setting values displayed on the setting screen for MIMO communication are set to different values.
